(19) United States
(12) Patent Application Publication
(10) Pub. No.: US 2003/0090245 A1
(43) Pub. Date: May 15, 2003

(54) Synchronous switched boost and buck converter

(76) Inventors: Krishna Shenai, Naperville, IL (US); Siamak Abedinpour, Chandler, AZ (US)

Correspondence Address: Robert J. Irvine III, McDonnell Boehnen Hulbert & Berghoff, 32nd Floor, 300 S. Wacker Drive, Chicago, IL, 60606, US

(21) Appl. No.: 10/288,987

(22) Filed: Nov. 5, 2002

Related U.S. Application Data
(60) Provisional application No. 60/337,479, filed on Nov. 5, 2001.

(51) Int. Cl. G05F 1/24

(52) U.S. Cl. 323/259

(57) ABSTRACT

A direct current voltage boost converter includes a substantially static direct current voltage source coupled with an inductor. The converter also includes a step-up switch coupled with the inductor, and a capacitor coupled with, and between, electrical ground, and the inductor and the step-up switch via a switching device for controlling current flow direction. The converter further includes a single control circuit coupled with the step-up switch, the switching device and an output terminal of the boost converter, wherein the control circuit opens and closes the step-up switch and the switching device substantially out of phase with each other. This out of phase switching effects voltage conversion and regulation based, at least in part, on a desired output voltage and an output voltage present on the output terminal of the boost converter.

### PRIORITY AND RELATED APPLICATIONS

The present patent application claims priority under 35 U.S.C. §119(e) to U.S. Provisional Patent Application Serial No. 60/337,479 entitled “Monolithic DC-DC Converter with Current Control for Improved Performance”; filed on Nov. 5, 2001, the full disclosure of which is incorporated herein by reference.

The following non-provisional patent applications are also incorporated by reference herein:

“DC-DC Converter with Resonant Gate Drive” to Shenai et al., Attorney Docket No. 02,795-A, filed concurrently herewith;

“Monolithic Battery Charging Device” to Shenai et al., Attorney Docket No. 02,796-A, filed concurrently herewith; and

“DC-DC Converter with Current Control” to Shenai et al., Attorney Docket No. 02,798-A, filed concurrently herewith.

### FIELD OF INVENTION

The present invention relates to power converters and, more specifically, to direct current voltage step-down converters (buck converters) and direct current voltage step-up converters (boost converters).

### BACKGROUND

Direct-current to direct current voltage converters (DC-DC converters) are used frequently in electrical and electronic systems to convert one voltage potential to another voltage potential. Such DC-DC converters typically have some form of regulation that controls an output voltage for the DC-DC converter as the electrical power consumed by an electrical load connected with the DC-DC converter changes. Such loads may include microprocessors, wireless communication devices, or any other electronic system or component that uses a DC voltage. Two common type of DC-DC converters may be referred to as boost and buck converters. Boost converters, as the term indicates, boost an input voltage to provide a higher voltage potential output voltage, relative to the input voltage. Conversely, buck converters reduce an input voltage to produce a lower output voltage, relative to the input voltage.

One challenge that is faced when designing DC-DC converters, such as boost and buck converters, is the efficiency of such converters. Efficiency may be measured by the ratio of output power to input power. Therefore, efficiency for a given DC-DC converter indicates the amount of power consumed, or lost, as a result of the conversion from the input voltage potential to the output voltage potential. Current approaches for implementing DC-DC converters may have efficiencies on the order of fifty to sixty-five percent. As electrical and electronic systems continue to increase in complexity, such power losses due to voltage conversion may present more significant design challenges. Therefore, alternative approaches for DC-DC converters may be desirable.

### SUMMARY

A direct current voltage boost converter in accordance with the invention includes a substantially static direct current voltage source coupled with an inductor. The converter also includes a step-up switch coupled with the inductor, and a capacitor coupled with, and between, electrical ground, and the inductor and the step-up switch via a switching device for controlling current flow direction. The converter further includes a single control circuit coupled with the step-up switch, the switching device and an output terminal of the boost converter, wherein the control circuit opens and closes the step-up switch and the switching device substantially out of phase with each other. This out of phase switching effects voltage conversion and regulation based, at least in part, on a desired output voltage and an output voltage present on the output terminal of the boost converter.

### BRIEF DESCRIPTION OF THE DRAWINGS

The subject matter regarded as the invention is particularly pointed out and distinctly claimed in the concluding portion of the specification. The invention, however, as to both organization and method of operation, together with features and advantages thereof, may best be understood by reference to the following detailed description when read with the accompanying drawings in which:

FIG. 1 is a schematic diagram illustrating a prior art direct current to direct current voltage step-up converter (boost converter);

FIG. 2 is a schematic drawing illustrating a prior art direct current to direct current voltage step-down converter (buck converter);

FIG. 3 is a schematic diagram illustrating an embodiment of a boost converter;

FIG. 4 is a schematic diagram illustrating an embodiment of a control circuit that may be used with the direct current voltage converter depicted in FIG. 3;

FIG. 5 is a schematic diagram illustrating an embodiment of a buck converter;

FIG. 6 is a schematic diagram illustrating an embodiment of a control circuit that may be used with the direct current voltage converter depicted in FIG. 5;

FIG. 7 is a schematic diagram illustrating an alternative embodiment of a boost converter;

FIG. 8 is a schematic diagram illustrating an embodiment of a control circuit that may be used with the voltage converter depicted in FIG. 7; and

FIG. 9 is a schematic diagram illustrating an embodiment of a timer circuit that maybe used with the control circuit depicted in FIG. 8.

### DETAILED DESCRIPTION

In the following detailed description, numerous specific details are set forth in order to provide a thorough understanding of the invention. However, it will be understood that the present invention may be practiced without these specific details. In other instances, well-known methods, procedures, components and circuits have not been described in detail, so as not to obscure the present invention.

As was previously indicated, current approaches for implementing boost and buck converters may have efficiencies in the range of fifty to sixty-five percent. Such efficiencies may create significant design challenges in certain applications, such as, for example, monolithic direct current to direct-current voltage converters (DC-DC converter) integrated on a semiconductor device with other circuitry. Such challenges may include power consumption, circuit element sizes for such DC-DC converters, among other issues.

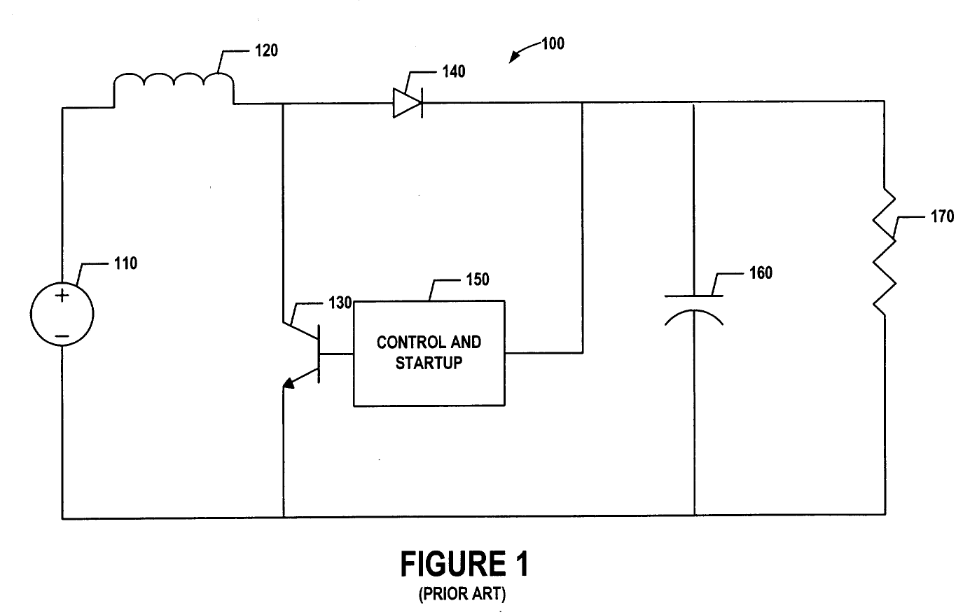

FIG. 1 is a schematic diagram that illustrates a prior art DC-DC boost converter 100 (hereafter “boost converter”), which illustrates some of the foregoing concerns. Boost converter 100 comprises a static direct current voltage source 110. The positive terminal of voltage source 110 is coupled with one terminal of an inductor 120. The other terminal of inductor 120 is coupled with a collector of an npn-type bipolar junction transistor (BJT) 130 and the anode of diode 140. Diode 140 acts as a voltage rectifying device in that diode 140 controls the direction of current flow from inductor 120 in converter 100. The cathode of diode 140 is coupled with an input terminal of control/startup circuit 150, one terminal of capacitor 160 and one terminal of a load resistance 170. The emitter of BJT 130 and the second terminals of capacitor 160 and load resistance 170 are coupled with electrical ground, as illustrated. An output terminal of control/startup circuit 150 is coupled with the base of BJT 130. Control/startup circuit 150 typically regulates the voltage across capacitor 160 and load resistance 170 using a pulse-width modulated or pulse-frequency modulated circuit to turn BJT 130, which may be termed the step-up switch, on and off. It will be appreciated that load resistance 170 may be merely illustrative and representative of a time varying impedance being powered by boost converter 100.

In operation, boost converter 100 accomplishes a step-up voltage conversion in the following manner. This description assumes that boost converter 100 is powered off and no initial voltage potentials are present in the circuit. BJT 130 may be turned on so that it conducts current, which may be referred to as closing the step-up switch. When BJT 130 is turned on, the voltage potential of voltage source 110 will appear across inductor 120. This voltage potential causes a current to ramp up through inductor 120. Subsequently, BJT 130 may be turned off. Turning BJT 130 off causes the voltage across inductor 120 to reverse, resulting in a higher voltage to be present at the anode of diode 140. The resulting voltage depends on the amount of time BJT 130 is turned on. Equations for determining such voltages are known, and will not be discussed here.

As a result of the voltage reversing across inductor 120, the voltage present at the anode of diode 140 is typically higher than the voltage supplied by input voltage source 110. This may be termed the stepped up voltage. The stepped up voltage may then be applied to capacitor 160 and load resistance 170 via diode 140. The voltage across capacitor 160 and load resistance 170 may be compared with a reference signal by control/startup circuit 150. The reference signal may be a pulse train, as in the case of pulse-width modulation control, or may be a reference voltage, as in the case of clocked pulse-frequency modulation control.

When the voltage across capacitor 160 and load resistance 170 exceeds a desired value, control/startup circuit 150 may turn BJT 130 on. In this situation, as was previously indicated, diode 140 functions so as to rectify the stepped-up voltage during conversion, thereby preventing capacitor 160 from discharging through BJT 130. This allows the voltage potential stored on capacitor 160 to be discharged into load resistance 170. Likewise, when the voltage across capacitor falls below the desired level, control/startup circuit 150 may turn off BJT 130 (open the step-up switch), which allows electrical energy stored in inductor 120 to be transferred to capacitor 160 and load resistance 170.

However, boost converter 100 suffers from at least some of the previously discussed disadvantages. For example, as the voltage drop associated with BJT 130 and diode 140 may affect the efficiency of converter 100. Additionally, for monolithically implemented boost converters, diode 140 would typically not be an efficient device due, at least in part, to processing constraints of semiconductor manufacturing processes. Such inefficiencies may further affect the overall efficiency of converter 100.

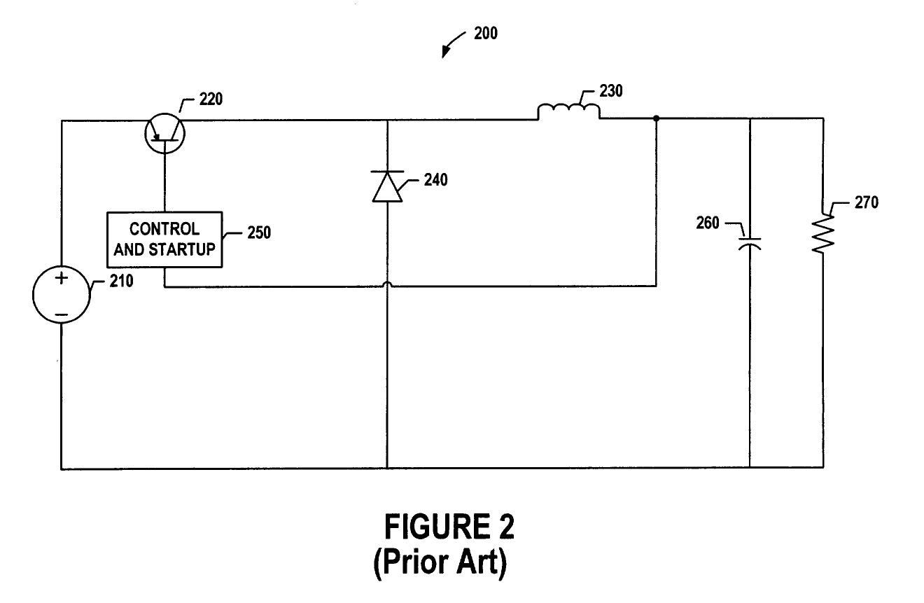

FIG. 2 is a schematic diagram illustrating such a prior-art buck converter 200. Buck converter 200 comprises a direct current voltage supply 210. Supply 210 is coupled with a switch 220, which takes the form of a bipolar transistor for this embodiment. Buck converter also includes inductor 230, diode 240, control circuit 250 and capacitor 260. Such a configuration is well-known and will not be discussed in detail here. Briefly, however, control circuit 250 typically includes a control signal (typically static or fixed frequency and duty cycle) and either a pulse-width-modulated (PWM) circuit or a pulse-frequency-modulated (PFM) circuit. In such configurations, the PWM or PFM circuit is coupled directly with switch 220. Such a configuration may suffer from the same inefficiencies due to BJT 220 and diode 240 as were discussed with respect to FIG. 1. Therefore, based on the foregoing alternative techniques for implementing boost and buck converters may be desirable.

Various exemplary embodiments of the invention will now be described. It will be appreciated, however, that the invention is not limited in scope to these particular embodiments, as many alternatives may exist. Also, specific implementations of such boost and buck converters may vary. For example, boost and buck converters in accordance with the invention may be implemented using discrete components or, alternatively, may be implemented monolithically on a single integrated circuit device.

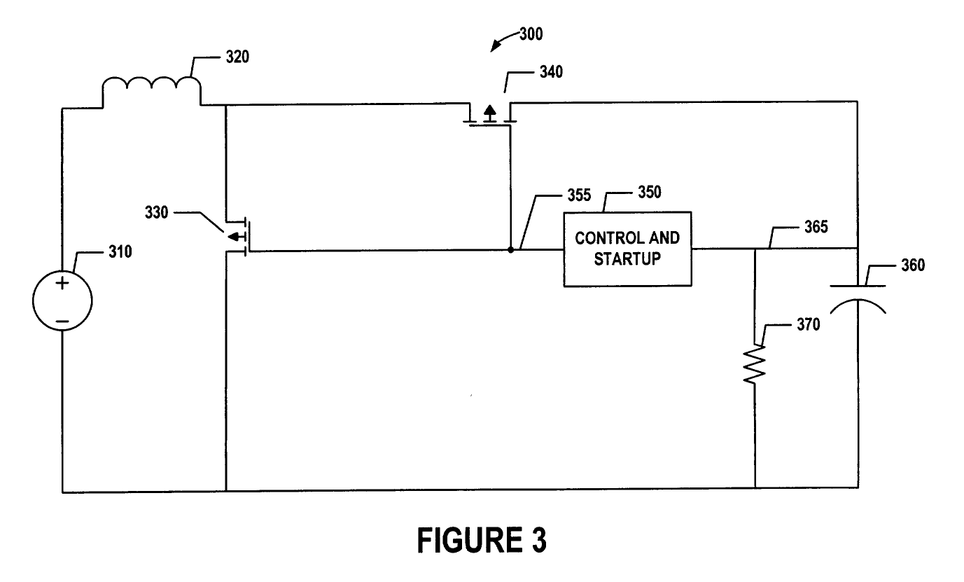

FIG. 3 is a schematic diagram illustrating an embodiment of a boost converter 300 according to an embodiment of the invention. Boost converter 300 includes a substantially static direct current voltage source 310. An inductor 320 is coupled with voltage source 310 for storing electrical energy to be used in generating an output voltage with boost converter 300. Inductor 320 is further coupled with a step-up switch. For this embodiment, the step-up switch takes the form of an n-type field effect transistor (FET) 330, though the invention is not so limited. Inductor 320 and step-up switch 330 are also coupled with a switching device that may be used to control current flow direction in boost converter 300. For this particular embodiment, the switching device takes the form of a p-type FET 340, though alternatives may exist.

Boost converter 300 also includes a capacitor 360 and load resistance 370 coupled with, and between, electrical ground and inductor 320, and n-type FET 330 via p-type FET 340. Capacitor 360 may store converted voltage and filter ripple on the output voltage of boost converter 300. Load resistance 370 is typically a time varying impedance for which buck converter 300 supplies a voltage.

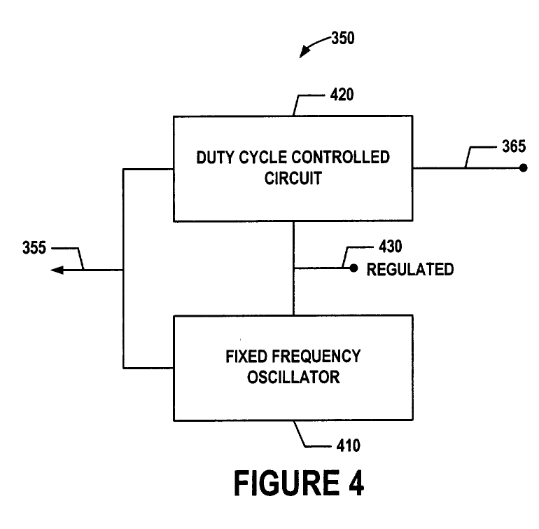

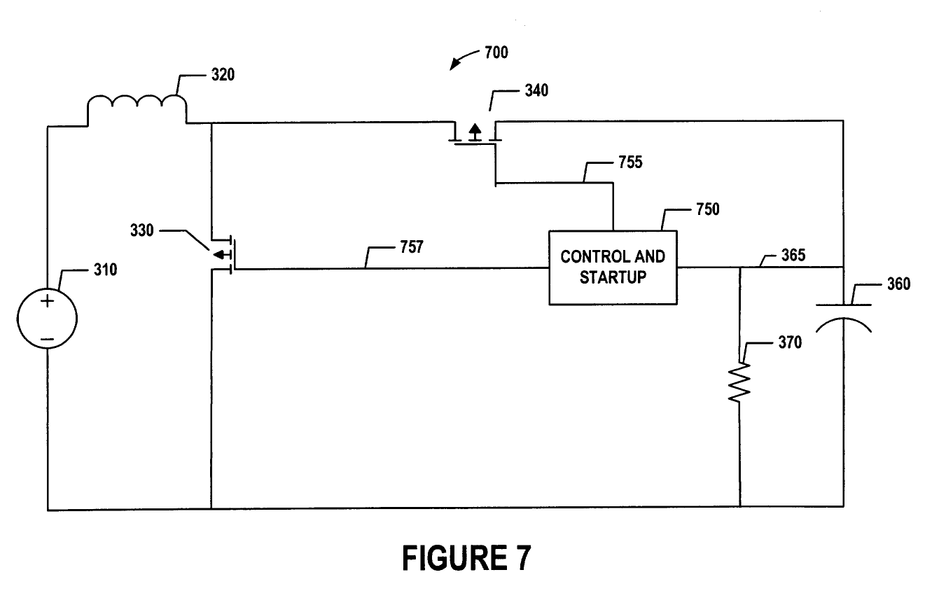

A single control circuit 350 is coupled with n-type FET 330, p-type FET 340 and an output terminal of boost converter 300. In this regard, control circuit 350 may compare the output voltage of boost converter 300 with a desired reference voltage. As a result of this comparison, control circuit 350 may open and close n-type FET 330 and p-type FET 340 substantially out of phase with each other to effect voltage conversion and regulation for boost converter 300 based, at least in part, on that comparison. Embodiments of such control circuits are discussed in further detail below with respect to FIGS. 4 and 7.

Such a configuration may be advantageous over prior approaches in a number of respects. In this regard, the use of FET devices 330 and 340 may improve the efficiency of boost converter 300 over prior configurations as the voltage drop across such FET devices when they are conducting is typically lower than the voltage drop across a forward biased diode or a conducting bipolar transistor. Also the use of n-type FET 330 and p-type FET 340 may be advantageous over embodiments that employ a single type of FET device (i.e. only n-type or only p-type). In this regard, a single gate drive circuit may be used to control both FET 330 and FET 340, where embodiments using only n-type or only p-type FETs typically employ two gate drive (control) circuits.

FIG. 4 is block diagram that illustrates an embodiment of control/startup circuit 350 that may be used with boost converter 300 as shown in FIG. 3. Control/startup circuit 350, as shown in FIG. 4, comprises a fixed frequency oscillator 410. Fixed frequency oscillator 410 may open and close n-type FET 330 and p-type FET 340 (out of phase with each other) to initialize boost converter 300 from a powered-off state to a regulated, powered-on state. Fixed frequency oscillator 310 may then be disabled once the boost converter is in the regulated, powered-on state.

Control/startup circuit 350 may further comprise a duty cycle controlled circuit 420. Duty cycle controlled circuit 420 may take the form of, for example, a pulse width modulated (PWM) circuit or a pulse-frequency modulated (PFM) circuit. Such circuits are known and will not be described in detail here. Duty cycle controlled circuit 420 may provide an indication that boost converter 300 is in a regulated, powered-on state via signal line 430. Alternatively, this indication may be provided from a circuit external to control/startup circuit 350. The signal on line 430 may indicate to fixed frequency oscillator 410 that boost converter 300 is in the regulated, powered-on state, resulting in fixed frequency oscillator 410 being disabled.

Signal line 365 may be used to communicate regulated output voltage information to control/startup circuit 350 when boost converter 300 is in the regulated, powered-on state. Fixed frequency oscillator 410 and duty cycle controlled circuit 420 may use signal line 355 to communicate signals that control the state (open or closed) of n-type FET 330 and p-type FET 340 to convert voltage from supply 310 and regulate the output voltage of boost converter 300 to approximate a desired output voltage.

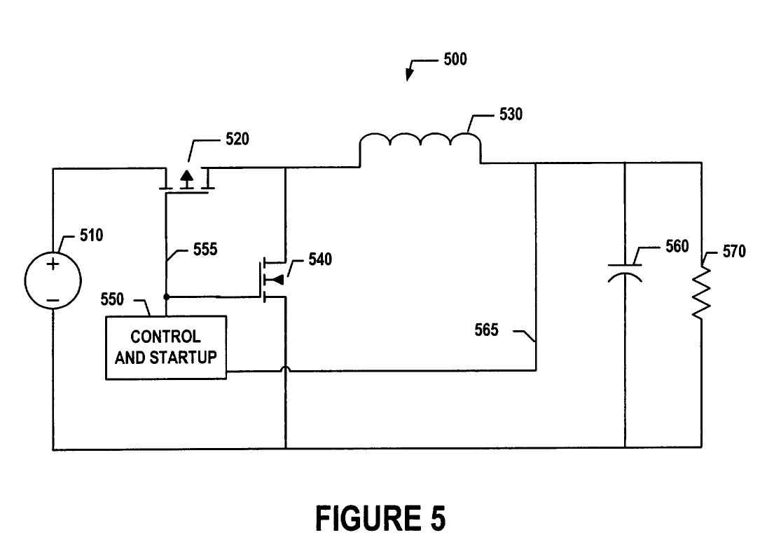

FIG. 5 is a schematic diagram that illustrates an embodiment of a buck converter 500 in accordance with the invention. Buck converter 500 includes a substantially static direct current voltage source 510, which provides an input voltage for buck converter 500. Voltage source 510 is coupled with a switching device, which for this embodiment takes the form of a p-type FET 520. The switching device is coupled with an inductor 530 and a rectifying device that may control the direction of current flow in buck converter 540. For this embodiment, the rectifying device takes the form of an n-type FET 540. Buck converter 500 also includes a capacitor 560 and load resistance 570 coupled with the inductor. Capacitor 560 may store converted voltage and filter ripple on the output voltage of buck converter 500. Load resistance 570 is typically a time varying impedance for which buck converter 500 supplies a voltage.

Buck converter 500 also includes a single control/startup circuit 550 that is coupled with p-type FET 520, n-type FET 540, and an output terminal of buck converter 500. In this regard, control/startup circuit 550 may compare the output voltage of boost converter 500 with a desired reference voltage. As a result of this comparison control circuit 550 may open and close p-type FET 520 and n-type FET 540 substantially out of phase with each other to effect voltage conversion and regulation based, at least in part, on that comparison. Embodiments of such control circuits are discussed in further detail below with respect to FIGS. 4 and 7. Such a configuration may be advantageous over prior approaches for the same reasons discussed with respect boost converter 300 depicted in FIG. 3.

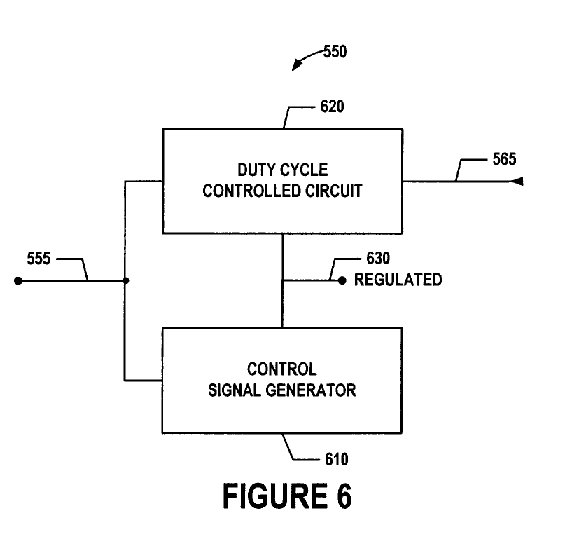

FIG. 6 is block diagram that illustrates an embodiment of control/startup circuit 550 that may be used with buck converter 500 as shown in FIG. 5. Control/startup circuit 550 comprises a control signal generator 610. Control signal generator 610 may close p-type FET 520 to initialize buck converter 500 from a powered-off state to a regulated, powered-on state. This may be termed a startup state for such a buck converter. In such embodiments, control signal generator 610 may then be disabled once the buck converter is in the regulated, powered-on state.

Control startup circuit 550 may further comprise a duty cycle controlled circuit 620. Duty cycle controlled circuit 620 may take the form of, for example, a PWM circuit or a PFM circuit, as was discussed with respect to FIG. 4. Duty cycle controlled circuit 620 may provide an indication that buck converter 500 is in a regulated, powered-on state via signal line 630. Alternatively, this indication may be provided from a circuit external to control/startup circuit 550. The signal on line 630 may indicate to control signal generator 610 that buck converter 500 is in the regulated, powered-on state, resulting in control signal generator 610 being disabled.

Signal line 565 may be used to communicate regulated output voltage information for buck converter 500 to control/startup circuit 550 when buck converter 500 is in the regulated, powered-on state. Control signal generator 610 and duty cycle controlled circuit 620 may use signal line 655 to communicate signals that control the state (open or closed) of p-type FET 520 and n-type FET 540 of buck converter 500 to convert voltage from supply 510 and regulate the output voltage of buck converter 500 to approximate a desired output voltage.

FIG. 7 is a schematic diagram that illustrates an embodiment of an alternative boost converter 700 in accordance with the invention. For this particular embodiment, boost converter 700 is similar to boost converter 300 shown in FIG. 3 in a number of respects. In this respect, analogous elements of boost converters 300 and 700 have like reference numbers. The specific details of these elements will not be addressed again with respect to FIG. 7.

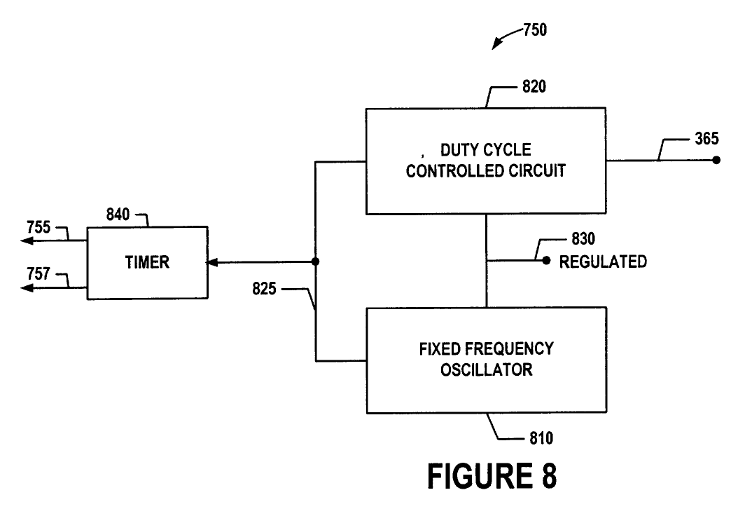

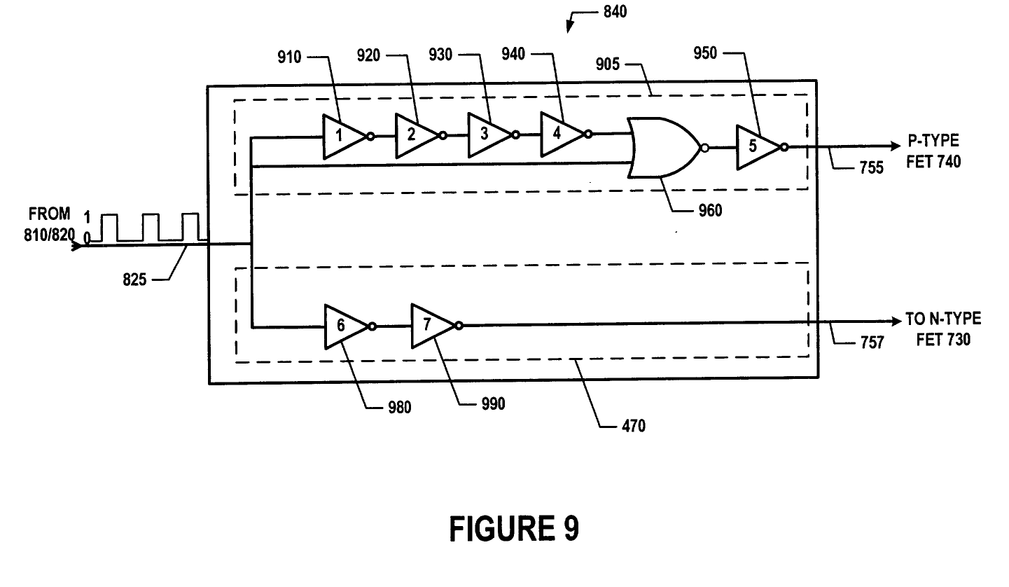

Boost converter differs from boost converter 300 in at least one area of note. Specifically, the control/startup circuit 750 of boost converter 700 has independent control signals for p-type FET 340 and n-type FET 330, which are respectively communicated on signal lines 755 and 757. Such a configuration may allow for p-type FET 340 and n-type FET 330 to be controlled so as to reduce shoot-through current when switching these devices. In this regard, control/startup circuit 750 may include a timer circuit to overlap the “off” times of p-type FET 340 and n-type FET 330. It is noted that such a configuration may also be used with buck converters in accordance with the invention to reduce the amount of shoot-through current in a similar fashion. Such a configuration for control/startup circuit 750 is now discussed in further detail with reference to FIGS. 8 and 9.

FIG. 8 is a schematic diagram that illustrates an embodiment of a control circuit 750 that may be used with boost converter 700, as shown in FIG. 7. It will be appreciated that the invention is not limited in scope to this particular embodiment and other configurations for control circuit 750 are possible. For the embodiment shown in FIG. 8, control circuit 750 includes a fixed frequency oscillator 810. Fixed frequency oscillator 810 may open and close n-type FET 330 and p-type FET 340 (out of phase with each other), via timer 840, to initialize boost converter 300 from a powered-off state to a regulated, powered-on state. The operation of timer 840, and its advantages, will described hereinafter with respect to FIG. 9. Fixed frequency oscillator 810 may then be disabled once boost converter 700 is in the regulated, powered-on state.

Control/startup circuit 750 may further comprise a duty cycle controlled circuit 820. Duty cycle controlled circuit 820 may take the form of, for example, a PWM circuit or a PFM circuit, as has been previously discussed. Duty cycle controlled circuit 820 may provide an indication that boost converter 700 is in a regulated, powered-on state via signal line 830. Alternatively, this indication may be provided from a circuit external to control/startup circuit 750. The signal on line 830 may indicate to fixed frequency oscillator 810 that boost converter 700 is in the regulated, powered-on state, resulting in fixed frequency oscillator 810 being disabled.

Signal line 365 may be used to communicate regulated output voltage information to control/startup circuit 750 when boost converter 700 is in the regulated, powered-on state. Fixed frequency oscillator 810 and duty cycle controlled circuit 820 may use signal line 825 to communicate signals for initializing and/or regulating boost converter 700 to timer 840. Timer 840 may then produce signals (in the manner described below) that are communicated to n-type FET 330 and p-type FET 340 (respectively, on signal lines 757 and 755) for converting voltage from supply 310 and regulating the output voltage of boost converter 700 to approximate a desired output voltage.

FIG. 9 is a schematic diagram illustrating an embodiment of timer circuit 840 that may be used in boost converter 700 and control circuit 750, as depicted in FIGS. 7 and 8. Timer circuit 840 may operate so as to effect overlapping “off” times for p-type FET 340 of boost converter 700 and n-type FET 330 or boost converter 700, so as to reduce shoot-through current from capacitor 360. In this regard, timer circuit 840 may operate such that the FETs (330 and 340) are not in a conduction state (“on”) simultaneously.

In this respect, timer 840 includes multiple circuit paths, 905 and 970, where each includes plural delay elements. Alternatively, single delay elements may be used. Such a configuration, as shown in FIG. 5, results in a signal that is communicated to an input terminal of the timer on signal line 825 (from fixed frequency oscillator 810 or duty cycle controlled circuit 820) propagating to the end of each of circuit paths 905 and 970 at different times. Also, circuit path 905 has a first delay time for a low state to high state transition and a second delay time for a high state to low state transition, where the second delay is longer than the first delay. While the specific operation of timer 840 is now described, it will be appreciated that many alternative timers may be used and the invention is not limited in scope to the use of this, or any particular timer circuit.

In operation, timer 840 receives a signal on signal line 825 from fixed frequency oscillator 810 or duty cycle controlled circuit 820. This signal is then communicated to both signal paths 905 and 970. Due to propagation delay for each of the inverters and the NOR gate included in timer 840, the signal received on signal line 905 results in p-type FET 340 of boost converter 700 and n-type FET 330 of boost converter 700 being controlled in the fashion described above with respect to “on” and “off” times.

In this regard, looking first at a transition from a low state to a high state on signal line 825, a NOR gate 960 of circuit path 905 produces (or transitions from a high state to) a low state, regardless of the initial state of its other input. This low state is communicated to a fifth inverter 950, which then inverts it to a high state. The high state is then communicated to p-type FET 340, turning it off.

The transition from low state to high state of the signal on line 905 is also communicated to a second circuit path 970. Circuit path 970 includes a sixth inverter 980 that inverts the high state to produce a low state. This low state is communicated to a seventh inverter 990, which inverts its incoming signal to produce a high state. The high state is then communicated to n-type FET 330 of boost converter 700, which switches it to its “on” state.

Like NOR gate 960 and fifth inverter 950, sixth 980 and seventh inverter 990 are in series. As such, the high state that is fed to n-type FET 330 lags behind the high state of the signal communicated from on signal line 925 by the combined propagation delay of sixth inverter 980 and seventh inverter 990, which may have the same duration or different duration.

The individual propagation delays of sixth inverter 980 and seventh inverter 990 may, respectively, have the same duration as NOR gate 960 and fifth inverter 950. Assuming that the propagation delay difference for the pinch-off of p-type FET 340 and n-type FET 330 is negligible, it is preferable, in this situation, that the combined propagation delay of sixth inverter 980 and seventh inverter 990 be longer than the combined propagation delay of NOR gate 960 and fifth inverter 950. Such a situation ensures that when n-type FET 330 switches to its “on” state, p-type FET 340 is already in its off state, reducing shoot-through current, as was previously described.

Looking now at a transition from high state to low state of a signal communicated to timer 840 on signal line 825, the signal is communicated to circuit path 970 and sixth inverter 980 inverts the low state to produce a high state. This high state is communicated to seventh inverter 990, which inverts its incoming signal to produce a low state. The low state is then communicated to n-type FET 330, which switches “off.”

For at least the combined propagation delay of a first, second, third and fourth inverter (910, 920, 930 and 940) the output of circuit path 905 remains unchanged after receiving the high-to-low state signal transition. Although the low state is communicated directly to the first input of NOR gate 960, the output of NOR gate 960 continues to provide a low state until fourth inverter 940 provides a low state signal. This period of time is at least the combined propagation delay of first, second, third and fourth inverters 910, 920, 930, 940.

When the fourth inverter provides the low state to the second input of NOR gate 960, the output of NOR gate 960 produces a high state signal that is fed to fifth inverter 970. Fifth inverter 970 then supplies a low state to p-type FET 340, which turns on. It is noted that, when used in conjunction with timer 910, p-type FET 340 and n-type FET 330 have overlapping “off” times, non-overlapping “on” times, and operate substantially out of phase with each other, which may reduce losses due to switching and shoot-through current, as has been previously described.

While certain features of the invention have been illustrated and described herein, many modifications, substitutions, changes and equivalents will now occur to those skilled in the art. It is, therefore, to be understood that the appended claims are intended to cover all such modifications and changes as fall within the true spirit of the invention.

What is claimed is:

1. A direct current voltage boost converter comprising:
a substantially static direct current voltage source;
an inductor;
a step-up switch coupled with the inductor;
a capacitor coupled with, and between, the electrical ground, and the inductor and the step-up switch via a switching device for controlling current flow direction;
a single control circuit coupled with the step-up switch, the switching device and an output terminal of the boost converter, wherein the control circuit opens and closes the step-up switch and the switching device substantially out of phase with each other to effect voltage conversion and regulation based, at least in part, on a desired output voltage and an output voltage present on the output terminal of the boost converter.

2. The boost converter of claim 1, wherein the step-up switch comprises an n-type field effect transistor (FET), and the control circuit is coupled with a gate of the n-type FET.

3. The boost converter of claim 1 wherein the switching device comprises a p-type field effect transistor (FET), and the control circuit is coupled with a gate of the p-type FET.

4. The boost converter of claim 1, wherein the control circuit further comprises a startup circuit for initializing the boost converter from a powered-off state to a regulated, powered-on state.

5. The boost converter of claim 4, wherein the startup circuit comprises a fixed frequency oscillator, which is enabled when initializing the boost converter and disabled when the boost converter is in the regulated, powered-on state.

6. The boost converter of claim 1, wherein the control circuits comprises a pulse-width modulated circuit for opening and closing the n-type FET and the p-type FET.

7. The boost converter of claim 1, wherein the control circuit comprises a pulse-frequency modulation circuit.

8. The boost converter of claim 1, wherein the control circuit comprises a timer circuit having plural circuit paths, wherein a first circuit path of the plural paths is coupled with the step-up switch and a second circuit path of the plural paths is coupled with the switching device, the first circuit path having a substantially fixed delay and the second path having first delay for a first signal transition and a second delay for a second signal transition, wherein the fixed delay is longer than the first delay and shorter than the second delay.

9. A direct current voltage buck converter comprising:
a substantially static direct current voltage source;
a switching device coupled with the voltage source;
a rectifying device coupled with, and between, the switching device and an electrical ground;
an inductor coupled with switching device and the rectifying device;
a capacitor coupled with, and between, the electrical ground and the inductor;
a single control circuit coupled with the switching device, the rectifying device, and an output terminal of the buck converter, wherein the control circuit opens and closes the switching device and the rectifying device substantially out of phase with each other to effect voltage conversion and regulation based, at least in part, on a desired output voltage and an output voltage present on the output terminal of the buck converter.

10. The buck converter of claim 9, wherein the rectifying device comprises an n-type field effect transistor (FET), and the control circuit is coupled with a gate of the n-type FET.

11. The buck converter of claim 9, wherein the switching device comprises a p-type field effect transistor (FET), and the control circuit is coupled with a gate of the p-type FET.

12. The buck converter of claim 9, wherein the control circuit further comprises a startup circuit for initializing the buck converter from a powered-off state to a regulated, powered-on state.

13. The buck converter of claim 12, wherein the startup circuit comprises a control signal generator that closes the switching device to initialize the buck converter from the powered-off state to the regulated, powered-on state and is disabled when the buck converter is in the regulated, powered-on state.

14. The buck converter of claim 9, wherein the control circuit comprises a pulse-width modulated circuit for opening and closing the switching device and the rectifying device.

15. The buck converter of claim 9, wherein the control circuit comprises a pulse-frequency modulation circuit for opening and closing the switching device and the rectifying device.

16. The buck converter of claim 9, wherein the control circuit comprises a timer circuit having plural circuit paths, wherein a first circuit path of the plural paths is coupled with the step-up switch and a second circuit path of the plural paths is coupled with the switching device, the first circuit path having a substantially fixed delay and the second path having first delay for a first signal transition and a second delay for a second signal transition, wherein the fixed delay is longer than the first delay and shorter than the second delay.
